(19) United States
(12) Patent Application Publication
(10) Pub. No.: US 2026/0122651 A1
(43) Pub. Date: Apr. 30, 2026

(54) ADAPTING SSB TRANSMISSION

(71) Applicant: Samsung Electronics Co., Ltd., Suwon-si (KR)

(72) Inventor: Hongbo Si, Allen, TX (US)

(21) Appl. No.: 19/351,250

(22) Filed: Oct. 6, 2025

Related U.S. Application Data
(60) Provisional application No. 63/712,081, filed on Oct. 25, 2024.
(60) Provisional application No. 63/719,808, filed on Nov. 13, 2024.
(60) Provisional application No. 63/767,916, filed on Mar. 6, 2025.

(51) Int. Cl. H04W 72/232; H04L 27/26; H04W 76/40

(52) U.S. Cl. CPC H04W 72/232; H04L 27/2607; H04W 76/40

(57) ABSTRACT

Apparatuses and methods for adapting synchronization signal block (SSB) transmission. A method of a user equipment (UE) in a wireless communication system includes receiving a set of higher layer parameters and determining, based on the set of higher layer parameters, a list of configurations for an adaptation of a synchronization signals and physical broadcast channel (SS/PBCH) blocks. The method includes receiving a physical downlink control channel (PDCCH) providing a downlink control information (DCI) format, determining a periodicity of the SS/PBCH blocks after the adaptation based on an indication in the DCI format, determining a system frame number (SFN) offset and a half frame index of the SS/PBCH blocks after the adaptation, determining half frames including the SS/PBCH blocks after the adaptation, and receiving, based on the half frames, the SS/PBCH blocks.

### CROSS-REFERENCE TO RELATED AND CLAIM OF PRIORITY

The present application claims priority under 35 U.S.C. § 119(e) to U.S. Provisional Ser. No. 63/712,081 filed on Oct. 25, 2024; U.S. Provisional Ser. No. 63/719,808 filed on Nov. 13, 2024; and U.S. Provisional Ser. No. 63/767,916 filed on Mar. 6, 2025, which are hereby incorporated by reference in their entirety.

### TECHNICAL FIELD

The present disclosure relates generally to wireless communication systems and, more specifically, the present disclosure is related to apparatuses and methods for adapting synchronization signal block (SSB) transmission.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to adapting SSB transmission.

In one embodiment, a base station (BS) in a wireless communication system is provided. The BS includes a processor configured to determine a list of configurations for an adaptation of synchronization signals and physical broadcast channel (SS/PBCH) blocks. Each configuration, from the list of configurations, provides a periodicity of the SS/PBCH blocks, a system frame number (SFN) offset associated with the periodicity, and a half frame index associated with the periodicity. The BS further includes a transceiver operably coupled to the processor. The transceiver is configured to transmit a set of higher layer parameters including the list of configurations. The processor is further configured to determine the periodicity of the SS/PBCH blocks after the adaptation based on an indication in a downlink control information (DCI) format, determine the SFN offset and the half frame index of the SS/PBCH blocks after the adaptation, determine, based on the periodicity, the SFN offset, and the half frame index, half frames including the SS/PBCH blocks after the adaptation. The transceiver is further configured to transmit a physical downlink control channel (PDCCH) providing the DCI format; and transmit, based on the half frames, the SS/PBCH blocks after the adaptation.

In another embodiment, a user equipment (UE) in a wireless communication system is provided. The UE includes a transceiver configured to receive a set of higher layer parameters and a processor operably coupled to the transceiver. The processor is configured to determine, based on the set of higher layer parameters, a list of configurations for an adaptation of SS/PBCH blocks. Each configuration, from the list of configurations, provides a periodicity of the SS/PBCH blocks, a SFN offset associated with the periodicity, and a half frame index associated with the periodicity. The transceiver is further configured to receive a PDCCH providing a DCI format. The processor is further configured to determine the periodicity of the SS/PBCH blocks after the adaptation based on an indication in the DCI format, determine the SFN offset and the half frame index of the SS/PBCH blocks after the adaptation, determine, based on the periodicity, the SFN offset, and the half frame index, half frames including the SS/PBCH blocks after the adaptation. The transceiver is further configured to receive, based on the half frames, the SS/PBCH blocks.

In yet another embodiment, a method of a UE in a wireless communication system is provided. The method includes receiving a set of higher layer parameters and determining, based on the set of higher layer parameters, a list of configurations for an adaptation of SS/PBCH blocks. Each configuration, from the list of configurations, provides a periodicity, a SFN offset associated with the periodicity, and a half frame index associated with the periodicity. The method includes receiving a PDCCH providing a DCI format, determining the periodicity of the SS/PBCH blocks after the adaptation based on an indication in the DCI format, determining the SFN offset and the half frame index of the SS/PBCH blocks after the adaptation, determining, based on the periodicity, the SFN offset, and the half frame index, half frames including the SS/PBCH blocks after the adaptation, and receiving, based on the half frames, the SS/PBCH blocks.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIGS. 5A and 5B illustrate example timelines for half frame determination according to embodiments of the present disclosure;

FIGS. 6A, 6B, and 6C illustrate an example timeline for half frame determination according to embodiments of the present disclosure;

FIGS. 7A, 7B, and 7C illustrate an example timeline for adapting transmission periodicity according to embodiments of the present disclosure; and

FIG. 8 illustrates a flowchart of an example UE procedure for adapting SSB transmission periodicity according to embodiments of the present disclosure.

### DETAILED DESCRIPTION

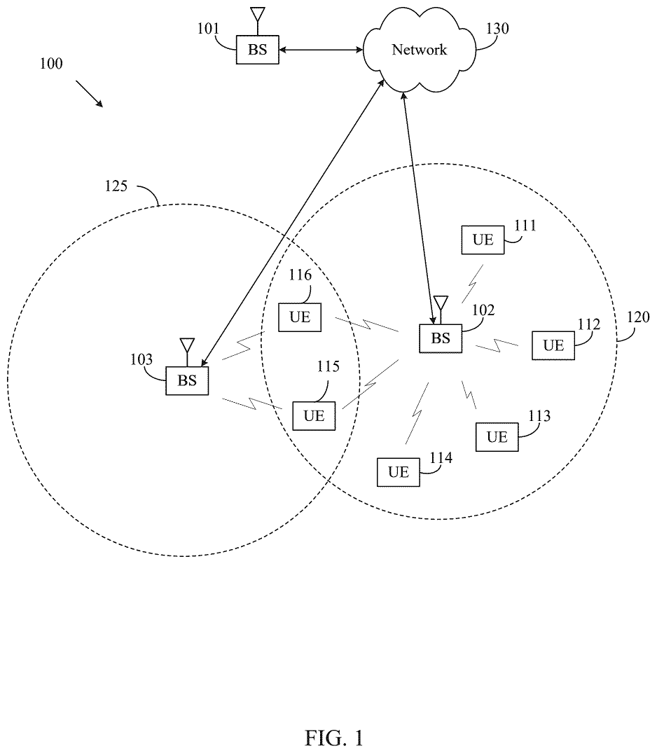

FIGS. 1-8 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v17.1.0, “NR; Physical channels and modulation;” [REF 2] 3GPP TS 38.212 v17.1.0, “NR; Multiplexing and channel coding;” [REF 3] 3GPP TS 38.213 v17.1.0, “NR; Physical layer procedures for control;” [REF 4] 3GPP TS 38.214 v17.1.0, “NR; Physical layer procedures for data;” and [REF 5] 3GPP TS 38.331 v17.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device. ” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for adapting SSB transmission. In certain embodiments, one or more of the BSs 101-103 include circuitry, programing, or a combination thereof to support adapting SSB transmission.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

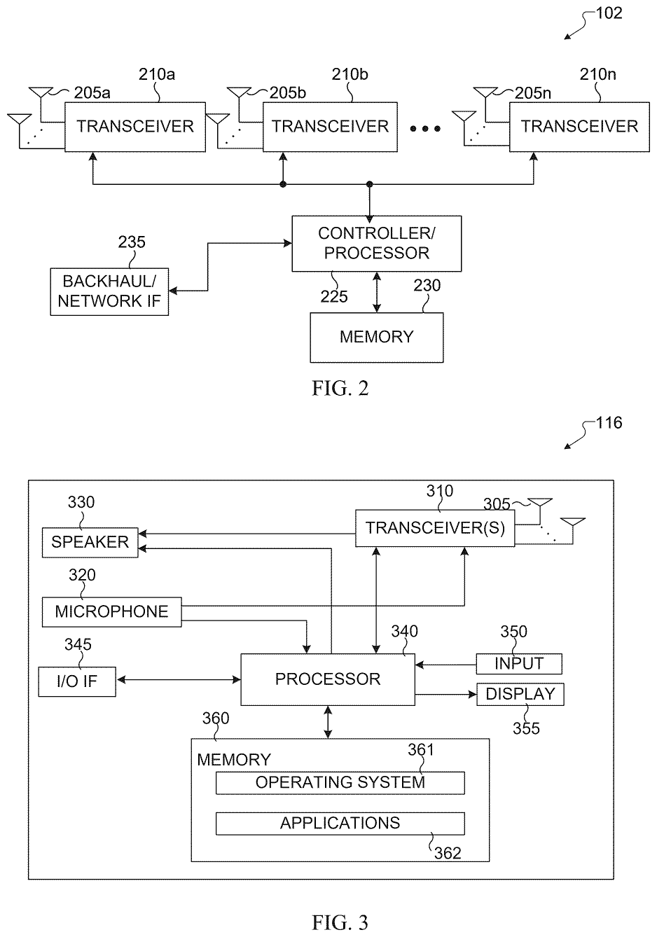

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for adapting SSB transmission. Any of a wide variety of other functions could be supported in the gNB 102 by the controller/processor 225.

The controller/processor 225 is also capable of executing programs and other processes resident in the memory 230, such as processes to support adapting SSB transmission. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

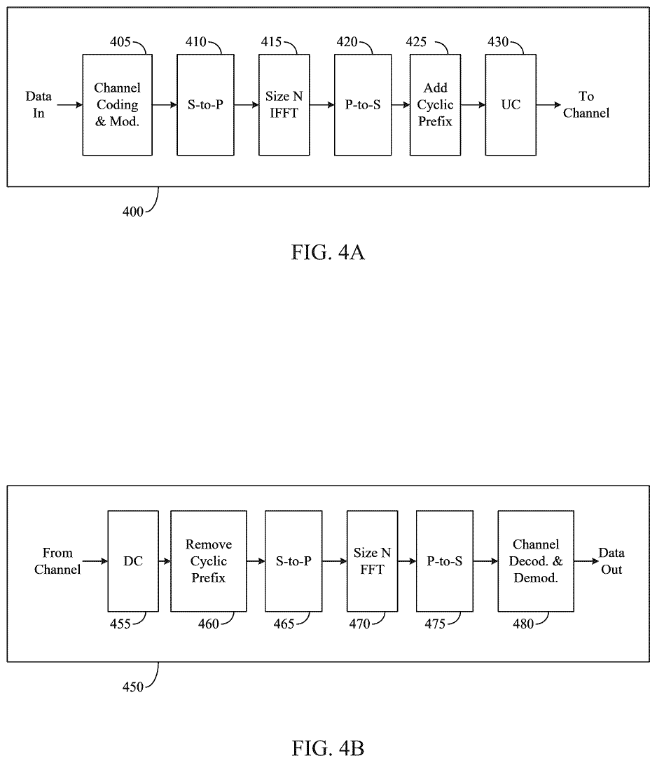

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for adapting SSB transmission as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

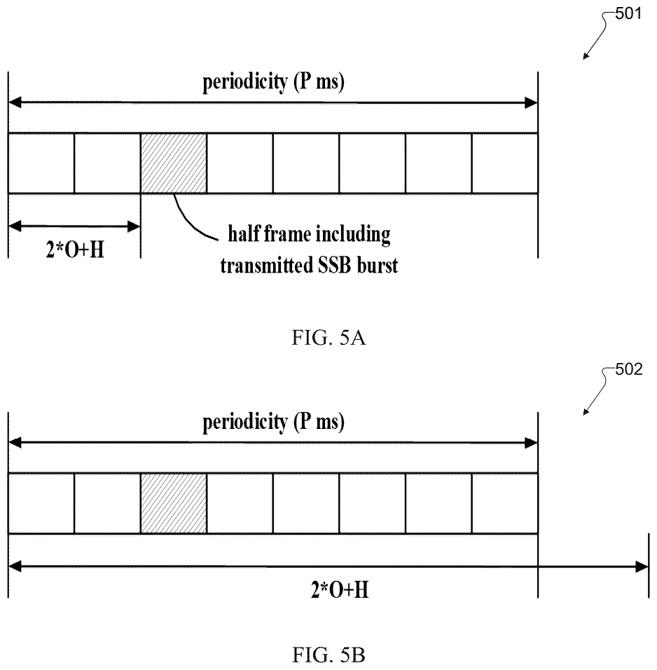

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for adapting SSB transmission as described in embodiments of the present disclosure. In some embodiments, the receive path 450 is configured for adapting SSB transmission as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In NR, a cell can be configured with SS/PBCH block (SSB) transmissions, wherein the transmissions are in a periodic manner and the periodicity of the SSB is configured by the gNB. For initial access procedure, e.g., the UE is not provided with the configuration of the periodicity of the SSB yet, the UE can assume the periodicity for the SSB transmission is 20 ms. After initial access procedure, the UE can acquire the configuration of the periodicity for the SSB transmission, and assume the SSB transmission following the configured periodicity. The UE (e.g., the UE 116) may not expect the periodicity for the SSB transmission varies if no reconfiguration of the parameter is provided to the UE.

The periodic transmission of SSB using a configured periodicity may result in high energy consumption from the network perspective. For example, when the data traffic is high or mobility of the UE is fast, the network (e.g., the network 130) may configure a short periodicity for the SSB transmission such that the UE may maintain good synchronization and perform good measurement in order to receive high amount of data and to adapt with the mobility. However, when the data traffic is low or mobility of the UE is slow, the network may not need to configure a short periodicity for the SSB transmission, and embodiments of the present disclosure recognize that it can save energy by configuring a long periodicity for the SSB transmission. In the wireless system, the reconfiguration of the periodicity for the SSB transmission can only be performed by RRC reconfiguration, which is not frequency and has long delay for UE processing. This disclosure provides dynamic adaptation of the periodicity for the SSB transmission, which can be triggered or indicated by a DL transmission such as a MAC CE (e.g., carried by at least one physical downlink shared channel (PDSCH)) or a downlink control information (DCI) format (e.g., carried by a physical downlink control channel (PDCCH)).

For one example, the adaptation of the periodicity for the SSB transmission can be applicable for RRC_CONNECTED mode.

For another example, the adaptation of the periodicity for the SSB transmission can be applicable for RRC_IDLE mode.

For yet another example, the adaptation of the periodicity for the SSB transmission can be applicable for RRC_INACTIVE mode.

For one example, the adaptation of the periodicity for the SSB transmission can be applicable for a PCell.

For another example, the adaptation of the periodicity for the SSB transmission can be applicable for a SCell.

For yet another example, the adaptation of the periodicity for the SSB transmission can be applicable for a PSCell.

For one example, the adaptation of the periodicity for the SSB transmission can be applicable for SSB as cell-defining SSB (e.g., with associated SIB1 transmission, e.g., such that the SSB can be used for acquiring the SIB1).

For another example, the adaptation of the periodicity for the SSB transmission can be applicable for SSB as non-cell-defining SSB (e.g., without associated SIB1 transmission, e.g., such that the SSB cannot be used for acquiring the SIB1).

For one example, the adaptation of the periodicity for the SSB transmission can be applicable for SSB located at a frequency layer given by a synchronization raster entry.

For another example, the adaptation of the periodicity for the SSB transmission can be applicable for SSB located at a frequency layer not given by a synchronization raster entry.

This disclosure provides adaptation of SSB transmission. More precisely, the following aspects are included in the disclosure:
Adaptation of periodicity for the SSB transmission
Adaptation of periodicity and time domain location of SSB burst within the periodicity
Adaptation of general configurations for SSB transmission
Timing to apply the adapted periodicity for SSB transmission
DL indication for triggering the adaptation
Example UE procedure In one embodiment, a UE can be provided with multiple periodicities for the SSB transmission by higher layer parameters, and the UE can receive a DL indication from the gNB (e.g., the BS 102) and determine which periodicity for the SSB transmission is activated/used based on the DL indication.

For one example, one of the multiple periodicities can be determined as a default one (e.g., the first one in the list of multiple periodicities, or a separate configuration as the default one). For one further evaluation, when the UE is not configured with additional periodicities, and/or not provided with the DL indication, the UE can determine to apply the default one as the periodicity for the SSB transmission. For another further evaluation, if the UE missed reception of the DL indication, e.g., for a pre-determined or configured time period, the UE can determine to apply the default one as the periodicity for the SSB transmission. For yet another further evaluation, the default periodicity can be determined as the largest one among the multiple periodicities. For yet another further evaluation, the default periodicity can be determined as the smallest one among the multiple periodicities. For yet another further evaluation, the default periodicity can be determined based on a SMTC (e.g., the default SMTC).

For another example, one of the multiple periodicities can be configured as a default/activated one (e.g., the first one in the list of multiple periodicities, or a separate configuration as the default one). For one further evaluation, when the UE is not configured with additional periodicities, and/or not provided with the DL indication, the UE can determine to apply the default/activated one as the periodicity for the SSB transmission. For another further evaluation, if the UE missed reception of the DL indication, e.g., for a pre-determined or configured time period, the UE can determine to apply the default one as the periodicity for the SSB transmission. For yet another further evaluation, the default periodicity can be determined as the largest one among the multiple periodicities. For yet another further evaluation, the default periodicity can be determined as the smallest one among the multiple periodicities. For yet another further evaluation, the default periodicity can be determined based on a SMTC (e.g., the default SMTC).

For one example, the DL indication has at least one explicit field to indicate which periodicity to be used after the adaptation (e.g., after receiving the DL indication), e.g., for a given cell.

For another example, the DL indication has at least one explicit field to indicate whether or which periodicity (other than the default periodicity) to be used after the adaptation (e.g., after receiving the DL indication), e.g., for a given cell.

For one example, at least one of the following parameters (e.g., provided by higher layer parameters or predefined or carried by the SSB) is common for SSB transmissions with different periodicities (e.g., before and after the DL indication):
Frequency location of the SSB (e.g., a global synchronization channel number (GSCN) for SSB located on sync raster, or an absolute radio-frequency channel number (ARFCN) for a SSB located on any frequency later);
Power of the SSB (e.g., ss-PBCH-BlockPower);
Actually transmitted SSB within a burst (e.g., ssb-PositionsInBurst);
Physical cell ID associated with the SSB (e.g., physicalCellId);
Subcarrier spacing of the SSB (e.g., subCarrierSpacing);
Subcarrier offset from common resource grid (e.g., k_SSB);
PBCH payload other than information related to timing, e.g., other than SFN (e.g., systemFrameNumber, ā_{Ā}, ā_{Ā+1}, ā_{Ā+2}, ā_{Ā+3}), or half frame index (e.g., ā_{Ā+4}), or (candidate) SSB index (or part of (candidate) SSB index, such as ā_{Ā+5}, ā_{Ā+6}, ā_{Ā+7}).
Time domain location of the half frame that includes SSB burst (e.g., SFN offset within a periodicity and/or a half frame index);
SSB-based measurement timing configuration (SMTC) (e.g., a periodicity in unit of subframes for measurement and an offset within the periodicity in the unit of subframes).

For one example, if a UE receives the DL indication indicating a same periodicity for SSB transmission, the UE can discard or ignore the adaptation, e.g., applying the same periodicity without further operation.

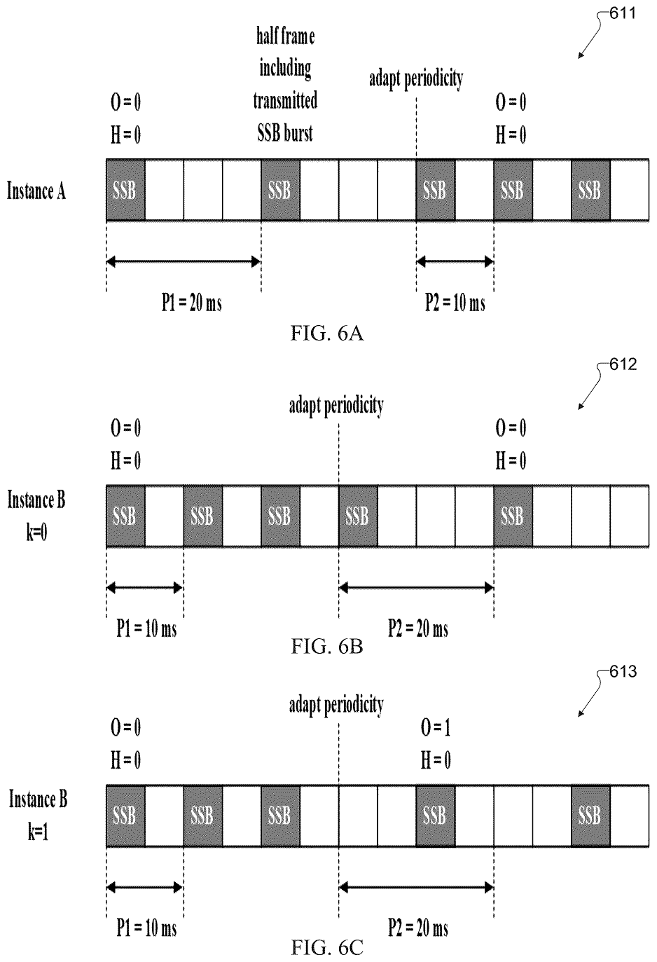

FIGS. 5A and 5B illustrate example timelines 501 and 502 for half frame determination according to embodiments of the present disclosure. For example, timelines 501 and 502 can be followed by any of the UEs 111-116 of FIG. 1, such as the UE 111. This example is for illustration only and other embodiments can be used without departing from the scope of the present disclosure.

For one example, time domain location of the half frame that includes SSB burst (e.g., SFN offset within a periodicity and/or a half frame index) can be provided by higher layer parameters, and is common for SSB transmissions (e.g., before and after the adaptation of the periodicity), e.g., not adapted with the adaptation of the periodicity.

• For one instance, denoting the periodicity for SSB transmission as P ms, wherein the half frames within one period with the periodicity P ms are indexed as 0, 1, . . . , P/5-1, and the SFN offset as O frames and half frame index as H (e.g., H=0 refer to the first half frame within a fame, and H=1 refers to the second half frame within a frame), then the half frames including SSB transmission with the periodicity of P ms can be determined as the ones with index ((2*O+H) mod (P/5)). An illustration of the instance is shown in FIG. 5A and FIG. 5B, wherein 501 in FIG. 5A illustrates the case of 2*O+H<P/5, and 502 in FIG. 5B illustrates the case of 2*O+H≥P/5.

For another example, time domain location of the half frame that includes SSB burst (e.g., SFN and/or a half frame index) can be included in the SSB, and the can determine such information based on the time domain location of the reception of the SSB.

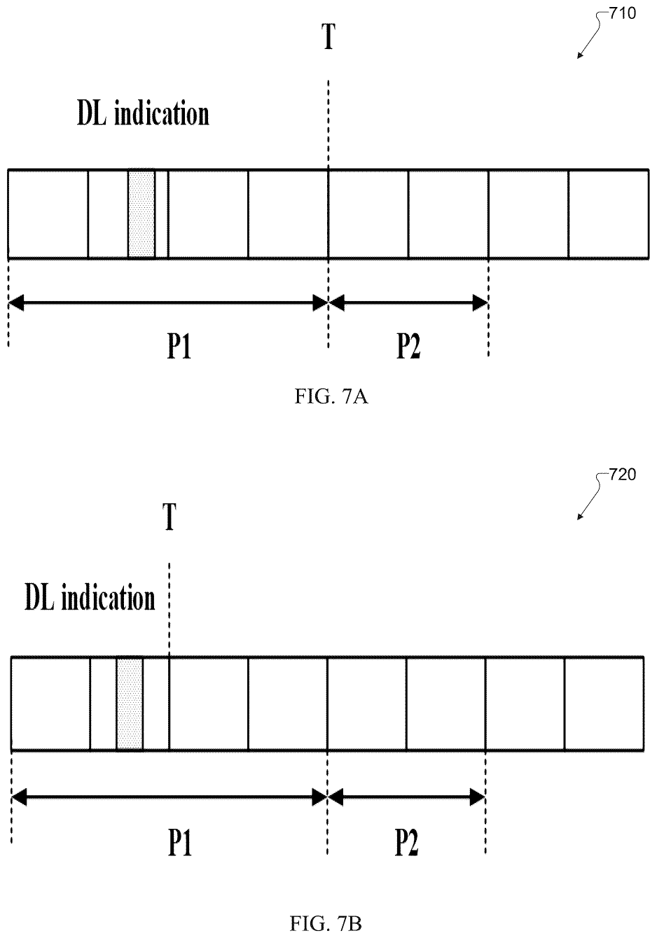

FIGS. 6A, 6B, and 6C illustrate an example timeline 611, 612, and 613, respectively, for half frame determination according to embodiments of the present disclosure. For example, timeline 611, 612, and 613, respectively, can be followed by any of the UEs 111-116 of FIG. 1, such as the UE 116. This example is for illustration only and other embodiments can be used without departing from the scope of the present disclosure.

For yet another example, time domain location of the half frame that includes SSB burst (e.g., SFN and/or a half frame index) may not be explicit configured or indicated to the UE, and the UE can determine a SFN offset within a periodicity (e.g., O frames as SFN offset within a periodicity of P1 ms) and/or a half frame index (e.g., H) based on the half frame including the reception of the SSB before adaptation (or without any adaptation), and the UE can determine the half frame that includes SSB transmission after adaptation (or with any adaptation) using at least one of the instances (e.g., Instance A and/or Instance B in FIGS. 6A, 6B, and 6C), wherein denoting the periodicity after adaptation (or with any adaptation) as P2 ms, and the half frames within the periodicity of P1 ms are index from 0 to P1/5-1, and the half frames within the periodicity of P2 ms are index from 0 to P2/5-1. For one further evaluation, Instance A and/or Instance B implies a nesting relationship between half frames including SSB transmission before and after adaptation, e.g., the half frames including SSB transmission with a larger periodicity is a subset of the half frames including SSB transmission with a smaller periodicity.
For one instance (e.g., Instance B in FIGS. 6B and 6C), if P1<P2, then the half frame that includes SSB transmission after adaptation (or with any adaptation) can be determined as one (e.g., UE determines one k value) from indexes 2*O+H+k*(P1/5), wherein k=0, 1, . . . , P2/P1−1. 612 in FIG. 6B illustrate the half frames including SSB transmission after adaptation for k=0, and 613 in FIG. 6C illustrate the half frames including SSB transmission after adaptation for k=1. For one further evaluation, a UE can determine a value of k by its implementation, e.g., blind detection of SSB within half frames with respect to different value of k. For another further evaluation, a UE can be provided with an explicit configuration in higher layer parameter or an explicit indication in the DL indication on which value of k to apply after adaptation. For yet another further evaluation, a UE can be provided with a different or additional measurement configuration (e.g., SMTC) after adaptation, and the UE can determine a value of k based on the different or additional measurement configuration.
For another instance (e.g., Instance A in FIG. 6A), if P1≥P2 or P1>P2, then the half frame that includes SSB transmission after adaptation (or with any adaptation) can be determined as ((2*O+H)mod(P2/5)), or (2*O+H).
For one further evaluation, the instances herein can also be applicable to SMTC, wherein P1 refers to the periodicity of SMTC before adaptation, P2 refers to the periodicity of SMTC after adaptation, and 2*O+H is the half frame offset for SMTC before adaptation, then the half frame offset for SMTC after adaptation can be according to at least one of Instance A and Instance B as described in the disclosure.
For another further evaluation, the relationship for the two instances can be equivalently described as satisfying (2*O_max+H_max)mod(P_min/5)=(2*O_min+H_min), wherein P_min the smaller periodicity between P1 and P2, and O_min and H_min are the SFN offset and half frame index corresponding to the smaller periodicity between P1 and P2, and O_min and H_min are the SFN offset and half frame index corresponding to the larger periodicity between P1 and P2.

For yet another example, time domain location of the half frame that includes SSB burst (e.g., SFN offset within a periodicity and/or a half frame index) can be included in the DL indication. The UE may use the indicated time domain location of the half frame that includes SSB burst to determine the half frame including SSB transmission after the adaptation of the periodicity.
For one instance, if the time domain location of the half frame that includes SSB burst is not included in the DL indication, the UE can assume a same value or a default value or a configured value of the SFN offset within the periodicity and/or half frame index is applied after the adaptation, e.g., using a method (e.g., without explicit configuration or indication) described in this disclosure.

In one embodiment, a UE can be provided with multiple periodicities for the SSB transmission and multiple time domain locations of the half frame (e.g., a SFN offset and a half frame index within the frame) that includes SSB burst by higher layer parameters, and the UE can receive a DL indication from the gNB and determine which periodicity and/or which time domain location of the half frame that includes SSB burst is activated/used for the SSB transmission based on the DL indication.

For one example, one of the multiple periodicities can be determined as a default one (e.g., the first one in the list of multiple periodicities, or a separate configuration as the default one). For one further evaluation, when the UE is not configured with additional periodicities, and/or not provided with the DL indication, the UE can determine to apply the default one as the periodicity for the SSB transmission. For another further evaluation, if the UE missed reception of the DL indication, e.g., for a pre-determined or configured time period, the UE can determine to apply the default one as the periodicity for the SSB transmission. For yet another further evaluation, the default periodicity can be determined as the largest one among the multiple periodicities. For yet another further evaluation, the default periodicity can be determined as the smallest one among the multiple periodicities. For yet another further evaluation, the default periodicity can be determined based on a SMTC (e.g., the default SMTC).

For another example, one of the multiple periodicities can be configured as a default/activated one (e.g., the first one in the list of multiple periodicities, or a separate configuration as the default one). For one further evaluation, when the UE is not configured with additional periodicities, and/or not provided with the DL indication, the UE can determine to apply the default/activated one as the periodicity for the SSB transmission. For another further evaluation, if the UE missed reception of the DL indication, e.g., for a pre-determined or configured time period, the UE can determine to apply the default one as the periodicity for the SSB transmission. For yet another further evaluation, the default periodicity can be determined as the largest one among the multiple periodicities. For yet another further evaluation, the default periodicity can be determined as the smallest one among the multiple periodicities. For yet another further evaluation, the default periodicity can be determined based on a SMTC (e.g., the default SMTC).

For one example, the DL indication has at least one explicit field to indicate which periodicity to be used after the adaptation (e.g., after receiving the DL indication), e.g., for a given cell.

For another example, the DL indication has at least one explicit field to indicate whether or which periodicity (other than the default periodicity) to be used after the adaptation (e.g., after receiving the DL indication), e.g., for a given cell.

For one example, one of the multiple time domain locations can be determined as a default one (e.g., the first one in the list of multiple time domain locations, or a separate configuration as the default one). For one further evaluation, when the UE is not configured with additional time domain locations, and/or not provided with the DL indication, the UE can determine to apply the default one as the time domain location for the SSB transmission. For another further evaluation, if the UE missed reception of the DL indication, e.g., for a pre-determined or configured time period, the UE can determine to apply the default one as the time domain location for the SSB transmission. For another further evaluation, the default time domain location can be determined as the first half frame within the periodicity, e.g., SFN offset is 0 and/or half frame index is 0. For yet another further evaluation, the default time domain location can be determined based on a SMTC (e.g., the default SMTC).

For another example, one of the multiple time domain locations can be configured as a default/activated one (e.g., the first one in the list of multiple time domain locations, or a separate configuration as the default one). For one further evaluation, when the UE is not configured with additional time domain locations, and/or not provided with the DL indication, the UE can determine to apply the default/activated one as the time domain location for the SSB transmission. For another further evaluation, if the UE missed reception of the DL indication, e.g., for a pre-determined or configured time period, the UE can determine to apply the default one as the time domain location for the SSB transmission. For another further evaluation, the default time domain location can be determined as the first half frame within the periodicity, e.g., SFN offset is 0 and/or half frame index is 0. For yet another further evaluation, the default time domain location can be determined based on a SMTC (e.g., the default SMTC).

For one example, the DL indication has at least one explicit field to indicate which time domain location to be used after the adaptation (e.g., after receiving the DL indication), e.g., for a given cell.

For another example, the DL indication has at least one explicit field to indicate whether or which time domain location (other than the default time domain location) to be used after the adaptation (e.g., after receiving the DL indication), e.g., for a given cell.

For one example, the higher layer parameter can provide a first list of periodicities, a second list of SFN offsets, and a third list of half frame indexes, wherein the number of components in the three lists are the same and have a one-to-one association, e.g., the k-th periodicity is associated with the k-th SFN offset and further associated with the k-th half frame index, in the corresponding lists. When a UE receives the DL indication to determine a periodicity for SSB transmission after adaptation, the UE also applies the associated SFN offset and the associated half frame index accordingly.

For another example, the higher layer parameter can provide a list of configurations (e.g., regarding the time domain information on the SSB), wherein each configuration at least includes a periodicity, a SFN offset, and a half frame index, associated with each other. When a UE receives the DL indication to determine which configuration (at least including periodicity, SFN offset, and half frame index) to apply after the adaptation.

For one example, at least one of the following parameters (e.g., provided by higher layer parameters or predefined or carried by the SSB) is common for SSB transmissions with different periodicities (e.g., before and after the DL indication):
Frequency location of the SSB (e.g., a GSCN for SSB located on sync raster, or a ARFCN for a SSB located on any frequency later);
Power of the SSB (e.g., ss-PBCH-BlockPower);
Actually transmitted SSB within a burst (e.g., ssb-PositionsInBurst);
Physical cell ID associated with the SSB (e.g., physicalCellId);
Subcarrier spacing of the SSB (e.g., subCarrierSpacing);
Subcarrier offset from common resource grid (e.g., k_SSB).
PBCH payload other than information related to timing, e.g., other than SFN (e.g., systemFrameNumber, ā_{Ā}, ā_{Ā+1}, ā_{Ā+2}, ā_{Ā+3}), or half frame index (e.g., ā_{Ā+4}), or (candidate) SSB index (or part of (candidate) SSB index, such as ā_{Ā+5}, ā_{Ā+6}, ā_{Ā+7}). For instance, SSBs with the same (candidate) SSB index have the same PBCH payload other than the SFN and the half frame index before and after the adaptation.

For one example, if a UE (e.g., the UE 116) receives the DL indication indicating a same periodicity and/or same time location for SSB transmission, the UE can discard or ignore the adaptation, e.g., applying the same periodicity and/or time location without further operation.

For one example, denoting the determined periodicity for SSB transmission as P ms, wherein the half frames within the periodicity P ms are indexed as 0, 1, . . . , P/5−1, and the determined SFN offset as O frames and half frame index as H (e.g., H=0 refer to the first half frame within a fame, and H=1 refers to the second half frame within a frame), then the half frames including SSB transmission with the periodicity of P ms can be determined as the ones with index ((2*O+H) mod (P/5)). For one further implementation, this example can be applicable when 2*O+H≥P/5.

For another example, denoting the determined periodicity for SSB transmission as P ms, wherein the half frames within the periodicity P ms are indexed as 0, 1, . . . , P/5−1, and the determined SFN offset as O frames and half frame index as H (e.g., H=0 refer to the first half frame within a fame, and H=1 refers to the second half frame within a frame), then the half frames including SSB transmission with the periodicity of P ms can be determined as the ones with index 2*O+H, and/or the UE expects 2*O+H<P/5.

For one example, if the time domain location of the half frame that includes SSB burst (e.g., SFN and/or a half frame index) is not indicated to the UE by the DL indication, the UE can assume to use the default time domain location.

For another example, if the time domain location of the half frame that includes SSB burst (e.g., SFN and/or a half frame index) is not indicated to the UE by the DL indication, the UE can determine the value of SFN offset within the periodicity (e.g., O frames) and/or the half frame index (e.g., H) based on the corresponding values before the adaptation. Expecting the periodicity before adaptation as P1 ms, and the periodicity after adaptation as P2 ms, and the half frames within the periodicity of P1 ms are index from 0 to P1/5−1, and the half frames within the periodicity of P2 ms are index from 0 to P2/5−1, then the half frames including SSB transmission after adaptation can be determined using at least one of the instances (e.g., Instance A and/or Instance B in FIGS. 6A, 6B, and 6C). For one further evaluation, Instance A and/or Instance B implies a nesting relationship between half frames including SSB transmission before and after adaptation, e.g., the half frames including SSB transmission with a larger periodicity is a subset of the half frames including SSB transmission with a smaller periodicity, which can also be interpreted as: the half frames including the SS/PBCH blocks after the adaptation are a subset of half frames including the SS/PBCH blocks before the adaptation, when the periodicity of the SS/PBCH blocks after the adaptation is larger than a periodicity of the SS/PBCH blocks before adaptation, and/or the half frames including the SS/PBCH blocks before the adaptation are a subset of the half frames including the SS/PBCH blocks after the adaptation, when the periodicity of the SS/PBCH blocks before the adaptation is larger than the periodicity of the SS/PBCH blocks after the adaptation.
For one instance (e.g., Instance B in FIGS. 6B and 6C), if P1<P2, then the half frame that includes SSB transmission after adaptation (or with any adaptation) can be determined as one (e.g., UE determines one k value) from indexes 2*O+H+k*(P1/5), wherein k=0, 1, . . . , P2/P1−1. 612 in FIG. 6B illustrate the half frames including SSB transmission after adaptation for k=0, and 613 in FIG. 6C illustrate the half frames including SSB transmission after adaptation for k=1. For one further evaluation, a UE can determine a value of k by its implementation, e.g., blind detection of SSB within half frames with respect to different value of k. For another further evaluation, a UE can be provided with an explicit configuration in higher layer parameter or an explicit indication in the DL indication on which value of k to apply after adaptation. For yet another further evaluation, a UE can be provided with a different or additional measurement configuration (e.g., SMTC) after adaptation, and the UE can determine a value of k based on the different or additional measurement configuration.
For another instance (e.g., Instance A in FIG. 6A), if P1≥P2 or P1>P2, then the half frame that includes SSB transmission after adaptation (or with any adaptation) can be determined as ((2*O+H) mod (P2/5)), or (2*O+H).
For one further evaluation, the instances herein can also be applicable to SMTC, wherein P1 refers to the periodicity of SMTC before adaptation, P2 refers to the periodicity of SMTC after adaptation, and 2*O+H is the half frame offset for SMTC before adaptation, then the half frame offset for SMTC after adaptation can be according to at least one of Instance A and Instance B as described in the disclosure.
For another further evaluation, the relationship for the two instances can be equivalently described as satisfying (2*O_max+H_max)mod(P_min/5)=(2*O_min+H_min), wherein P_min the smaller periodicity between P1 and P2, and O_min and H_min are the SFN offset and half frame index corresponding to the smaller periodicity between P1 and P2, and O_min and H_min are the SFN offset and half frame index corresponding to the larger periodicity between P1 and P2.

In one embodiment, a UE can be provided with multiple sets of configuration values for SSB transmission, and the UE can receive a DL indication from the gNB (e.g., the BS 102) and determine which set of configuration values is activated/used for the SSB transmission based on the DL indication.

For one example, one of the multiple sets of configuration values can be determined as a default set (e.g., the first one in the list of multiple sets of configuration values, or a separate configuration as the default one). For one further evaluation, when the UE is not configured with additional sets of configuration, and/or not provided with the DL indication, the UE can determine to apply the default set for the SSB transmission. For another further evaluation, if the UE missed reception of the DL indication, e.g., for a pre-determined or configured time period, the UE can determine to apply the default one for the SSB transmission.

For another example, one of the multiple sets of configuration values can be configured as a default/activated one (e.g., the first one in the list of multiple sets of configuration values, or a separate configuration as the default one). For one further evaluation, when the UE is not configured with additional sets of configuration, and/or not provided with the DL indication, the UE can determine to apply the default/activated set for the SSB transmission. For another further evaluation, if the UE missed reception of the DL indication, e.g., for a pre-determined or configured time period, the UE can determine to apply the default one for the SSB transmission.

For one example, the DL indication has at least one explicit field to indicate which set of configuration values to be used after the adaptation (e.g., after receiving the DL indication), e.g., for a given cell.

For another example, the DL indication has at least one explicit field to indicate whether or which set of configuration values (other than the default set of configuration values) to be used after the adaptation (e.g., after receiving the DL indication), e.g., for a given cell.

For one example, values of at least one of the following parameters (e.g., provided by higher layer parameters or predefined or carried by the SSB) can be included in one set of configuration values:
Frequency location of the SSB (e.g., a GSCN for SSB located on sync raster, or a ARFCN for a SSB located on any frequency later);
Power of the SSB (e.g., ss-PBCH-BlockPower);
Actually transmitted SSB within a burst (e.g., ssb-PositionsInBurst);
Physical cell ID associated with the SSB (e.g., physicalCellId);
Subcarrier spacing of the SSB (e.g., subCarrierSpacing);
Subcarrier offset from common resource grid (e.g., k_SSB);
Time domain location of the half frame that includes SSB burst (e.g., SFN offset within a periodicity and/or a half frame index);
Periodicity of the SSB (ssb-PeriodicityServingCell);
SSB-based measurement timing configuration (SMTC) (e.g., a periodicity in unit of subframes for measurement and an offset within the periodicity in the unit of subframes), so that a UE can perform the SSB-based measurement based on the SMTC.
PBCH payload other than information related to timing, e.g., other than SFN (e.g., systemFrameNumber, ā_{Ā}, ā_{Ā+1}, ā_{Ā+2}, ā_{Ā+3}), or half frame index (e.g., ā_{Ā+4}), or (candidate) SSB index (or part of (candidate) SSB index, such as ā_{Ā+5}, ā_{Ā+6}, ā_{Ā+7}).

For one example, if a UE receives the DL indication indicating a same set of configurations for SSB transmission, the UE can discard or ignore the adaptation, e.g., applying the same set of configurations without further operation.

For one example, denoting the periodicity for SSB transmission as P ms, wherein the half frames within the periodicity P ms are indexed as 0, 1, . . . , P/5−1, and the SFN offset as O frames and half frame index as H (e.g., H=0 refer to the first half frame within a fame, and H=1 refers to the second half frame within a frame), then the half frames including SSB transmission with the periodicity can be determined as the ones with index ((2*O+H)mod(P/5)). For one further implementation, this example can be applicable when 2*O+H≥P/5.

For another example, denoting the periodicity for SSB transmission as P ms, wherein the half frames within the periodicity P ms are indexed as 0, 1, . . . , P/5−1, and the SFN offset as O frames and half frame index as H (e.g., H=0 refer to the first half frame within a fame, and H=1 refers to the second half frame within a frame), then the half frames including SSB transmission with the periodicity can be determined as the ones with index 2*O+H, and the UE expects 2*O+H<P/5.

For yet another example, if the time domain location of the half frame that includes SSB burst (e.g., SFN and/or a half frame index) is not indicated to the UE by the DL indication, the UE can determine the value of SFN offset within the periodicity (e.g., O frames) and/or the half frame index (e.g., H) based on the corresponding values before the adaptation. Expecting the periodicity before adaptation as P1 ms, and the periodicity after adaptation as P2 ms, and the half frames within the periodicity of P1 ms are index from 0 to P1/5−1, and the half frames within the periodicity of P2 ms are index from 0 to P2/5−1, then the half frames including SSB transmission after adaptation can be determined using at least one of the instances (e.g., Instance A and/or Instance B in FIGS. 6A, 6B, and 6C). For one further evaluation, Instance A and/or Instance B implies a nesting relationship between half frames including SSB transmission before and after adaptation, e.g., the half frames including SSB transmission with a larger periodicity is a subset of the half frames including SSB transmission with a smaller periodicity.
For one instance (e.g., Instance B in FIGS. 6B and 6C), if P1<P2, then the half frame that includes SSB transmission after adaptation (or with any adaptation) can be determined as one (e.g., UE determines one k value) from indexes 2*O+H+k*(P1/5), wherein k=0, 1, . . . , P2/P1−1. 612 in FIG. 6B illustrate the half frames including SSB transmission after adaptation for k=0, and 613 in FIG. 6C illustrate the half frames including SSB transmission after adaptation for k=1. For one further evaluation, a UE can determine a value of k by its implementation, e.g., blind detection of SSB within half frames with respect to different value of k. For another further evaluation, a UE can be provided with an explicit configuration in higher layer parameter or an explicit indication in the DL indication on which value of k to apply after adaptation. For yet another further evaluation, a UE can be provided with a different or additional measurement configuration (e.g., SMTC) after adaptation, and the UE can determine a value of k based on the different or additional measurement configuration.
For another instance (e.g., Instance A in FIG. 6A), if P1≥P2 or P1>P2, then the half frame that includes SSB transmission after adaptation (or with any adaptation) can be determined as ((2*O+H)mod(P2/5)), or (2*O+H).
For one further evaluation, the instances herein can also be applicable to SMTC, wherein P1 refers to the periodicity of SMTC before adaptation, P2 refers to the periodicity of SMTC after adaptation, and 2*O+H is the half frame offset for SMTC before adaptation, then the half frame offset for SMTC after adaptation can be according to at least one of Instance A and Instance B as described in the disclosure.
For another further evaluation, the relationship for the two instances can be equivalently described as satisfying (2*O_max+H_max)mod(P_min/5)=(2*O_min+H_min), wherein P_min the smaller periodicity between P1 and P2, and O_min and H_min are the SFN offset and half frame index corresponding to the smaller periodicity between P1 and P2, and O_min and H_min are the SFN offset and half frame index corresponding to the larger periodicity between P1 and P2.

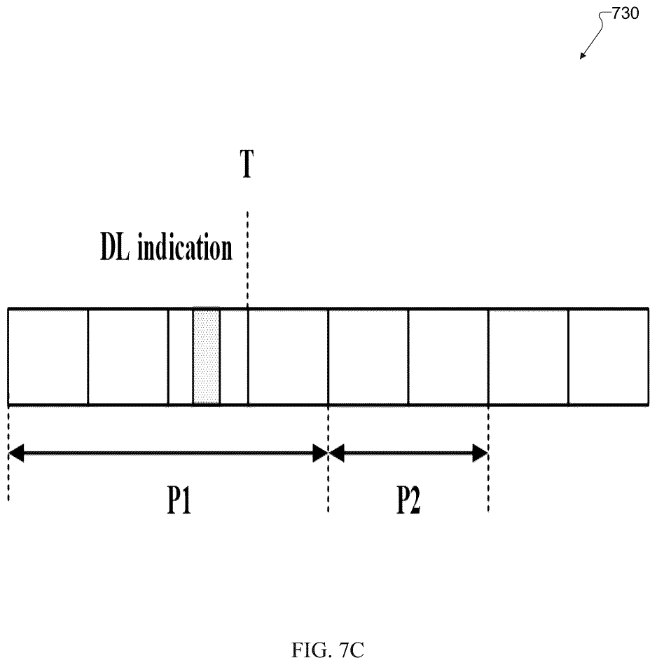

FIGS. 7A, 7B, and 7C illustrate an example timeline 710, 720, and 730, respectively, for adapting transmission periodicity according to embodiments of the present disclosure. For example, timeline 710, 720, and 730, respectively, can be followed by any of the UEs 111-116 of FIG. 1, such as the UE 113. This example is for illustration only and other embodiments can be used without departing from the scope of the present disclosure.

In one embodiment, after a UE receives a DL indication on adapting at least the periodicity for the SSB transmission, the UE can determine a time instance after the reception of the DL indication wherein the periodicity after adaptation is applied from the time instance. Denoting the periodicity (either for SSB transmission or for SMTC) before adaptation as P1 ms, and denoting the periodicity (either for SSB transmission or for SMTC) after adaptation as P2 ms.

For one example, the time instance T can be the start of the first half frame or first SMTC window after the reception of the DL indication satisfying at least one of the following instances.
For one instance, the offset from the reception of the DL indication (e.g., the slot or the last slot within the slots including the DL indication) to T is no less than a threshold T_min.

For another example, the time instance T can be the start of the first half frame or first SMTC window after the reception of the DL indication satisfying at least one of the following instances.
For one instance, the offset from the reception of the DL indication (e.g., the slot or the last slot within the slots including the DL indication) to (the first slot including) the first actually transmitted SSB after the adaptation is no less than a threshold T_min.

For yet another example, the time instance T can be the start of the first half frame or first SMTC window after the reception of the DL indication satisfying at least one of the following instances.
For one instance, the end of the previous half frame (e.g., or time instance T) is aligned with an end of a periodicity of P1 ms, e.g., T mod P1=0. For this instance, the UE assumes to perform adaptation at least after the period of P1 ms including the DL indication. An illustration of the instance is shown in FIG. 7A.
For another instance, the offset from the reception of the DL indication (e.g., the slot or the last slot within the slots including the DL indication) to T is no less than a threshold T_min.

For yet another example, the time instance T can be the start of the first half frame or first SMTC window after the reception of the DL indication satisfying at least one of the following instances.
For one instance, the end of the previous half frame (e.g., or time instance T) is aligned with an end of a periodicity of P1 ms, e.g., T mod P1=0. For this instance, the UE assumes to perform adaptation at least after the period of P1 ms including the DL indication. An illustration of the instance is shown in FIG. 7A.
For another instance, the offset from the reception of the DL indication (e.g., the slot or the last slot within the slots including the DL indication) to (the first slot including) the first actually transmitted SSB after the adaptation is no less than a threshold T_min.

For yet another example, the time instance T can be the start of the first half frame or first SMTC window after the reception of the DL indication satisfying at least one of the following instances.
For one instance, the end of the previous half frame (e.g., or time instance T) is aligned with an end of a periodicity of P1 ms, e.g., T mod P2=0. For this instance, the UE assumes to perform adaptation at least after the period of P2 ms including the DL indication.
For another instance, the offset from the reception of the DL indication (e.g., the slot or the last slot within the slots including the DL indication) to T is no less than a threshold T_min.

For yet another example, the time instance T can be the start of the first half frame or first SMTC window after the reception of the DL indication satisfying at least one of the following instances.
For one instance, the end of the previous half frame (e.g., or time instance T) is aligned with an end of a periodicity of P2 ms, e.g., T mod P2=0. For this instance, the UE assumes to perform adaptation at least after the period of P2 ms including the DL indication.
For another instance, the offset from the reception of the DL indication (e.g., the slot or the last slot within the slots including the DL indication) to (the first slot including) the first actually transmitted SSB after the adaptation is no less than a threshold T_min.

For yet another example, the time instance T can be the start of the first half frame or first SMTC window after the reception of the DL indication satisfying at least one of the following instances.
For one instance, the end of the previous half frame (e.g., or time instance T) is aligned with an end of a periodicity of P_min=min(P1, P2) ms, e.g., T mod P_min=0. For this instance, the UE assumes to perform adaptation at least after the period of P_min ms including the DL indication. An illustration of the instance is shown in FIG. 7B.
For another instance, the offset from the reception of the DL indication (e.g., the slot or the last slot within the slots including the DL indication) to T is no less than a threshold T_min.

For yet another example, the time instance T can be the start of the first half frame or first SMTC window after the reception of the DL indication satisfying at least one of the following instances.
For one instance, the end of the previous half frame (e.g., or time instance T) is aligned with an end of a periodicity of P_min=min(P1, P2) ms, e.g., T mod P_min=0. For this instance, the UE (e.g., the UE 116) assumes to perform adaptation at least after the period of P_min ms including the DL indication. An illustration of the instance is shown in FIG. 7B.
For another instance, the offset from the reception of the DL indication (e.g., the slot or the last slot within the slots including the DL indication) to (the first slot including) the first actually transmitted SSB after the adaptation is no less than a threshold T_min.

For yet another example, the time instance T can be the start of the first half frame or first SMTC window after the reception of the DL indication satisfying at least one of the following instances.
For one instance, the end of the previous half frame (e.g., or time instance T) is aligned with an end of a periodicity of P_max=max(P1, P2) ms, e.g., T mod P_max=0. For this instance, the UE assumes to perform adaptation at least after the period of P_max ms including the DL indication.
For another instance, the offset from the reception of the DL indication (e.g., the slot or the last slot within the slots including the DL indication) to T is no less than a threshold T_min.

For yet another example, the time instance T can be the start of the first half frame or first SMTC window after the reception of the DL indication satisfying at least one of the following instances.
For one instance, the end of the previous half frame (e.g., or time instance T) is aligned with an end of a periodicity of P_max=max(P1, P2) ms, e.g., T mod P_max=0. For this instance, the UE assumes to perform adaptation at least after the period of P_max ms including the DL indication.
For another instance, the offset from the reception of the DL indication (e.g., the slot or the last slot within the slots including the DL indication) to (the first slot including) the first actually transmitted SSB after the adaptation is no less than a threshold T_min.

For one example, the time instance T can be the start of the first half frame or first SMTC window after the reception of the DL indication satisfying at least one of the following instances.
For one instance, the SSB transmission burst within the same period as the slot (or ending slot within slots) including the DL indication using the periodicity P1 ms occurs no later than the half frame starting from time instance T. For this instance, the UE assumes to perform adaptation at least after the half frame including the DL indication. An illustration of the instance is shown in FIG. 7C.

For another instance, the offset from the reception of the DL indication (e.g., the slot or the last slot within the slots including the DL indication) to T is no less than a threshold T_min.

For another example, the time instance T can be the start of the first half frame or first SMTC window after the reception of the DL indication satisfying at least one of the following instances.
For one instance, the SSB transmission burst within the same period as the slot (or ending slot within slots) including the DL indication using the periodicity P1 ms occurs no later than the half frame starting from time instance T. For this instance, the UE assumes to perform adaptation at least after the half frame including the DL indication. An illustration of the instance is shown in FIG. 7C.
For another instance, the offset from the reception of the DL indication (e.g., the slot or the last slot within the slots including the DL indication) to (the first slot including) the first actually transmitted SSB after the adaptation is no less than a threshold T_min.

For one example, the time instance T can be the start of the first half frame or first SMTC window after the reception of the DL indication satisfying at least one of the following instances.
For one instance, the SSB transmission burst within the same period as the slot n+T_min using the periodicity P1 ms occurs no later than the half frame starting from time instance T, wherein n is the slot (or ending slot within slots) including the DL indication.

For another instance, the offset from the reception of the DL indication (e.g., the slot or the last slot within the slots including the DL indication) to T is no less than a threshold T_min.

For another example, the time instance T can be the start of the first half frame or first SMTC window after the reception of the DL indication satisfying at least one of the following instances.
For one instance, the SSB transmission burst within the same period as the slot n+T_min using the periodicity P1 ms occurs no later than the half frame starting from time instance T, wherein n is the slot (or ending slot within slots) including the DL indication.
For another instance, the offset from the reception of the DL indication (e.g., the slot or the last slot within the slots including the DL indication) to (the first slot including) the first actually transmitted SSB after the adaptation is no less than a threshold T_min.

For one further evaluation of examples herein, the first actually transmitted SSB after the adaptation is within a slot which is the first slot after the slot (or ending slot within slots) including the DL indication, and/or at least T_min from the slot (or ending slot within slots) including the DL indication, and/or includes (first) candidate SSB corresponding to the first actually transmitted SSB index within a burst, and/or located in a (first) half frame determined based on the periodicity/SFN offset/half fame index after the adaptation (e.g., according to an example of this disclosure).

For another further evaluation of examples herein, the T_min can be pre-determined in the specification of system operation.

For yet another further evaluation of examples herein, the T_min can be configured by the gNB (e.g., the BS 102), e.g., using higher layer parameter such as dedicated RRC including SCell configuration, or system information block.

For yet another further evaluation of examples herein, a UE can report at least one value of T_min it can support as a UE capability.

For yet another further evaluation of examples herein, a UE can indicate at least one value of T_min as its preferred value, e.g., in the UE assistant information (UAI).

In one embodiment, the DL indication can be a MAC CE (e.g., carried by at least one PDSCH).

For one example, the MAC CE can be the MAC CE used for on-demand SSB activation, and/or deactivation, and/or adaptation. For this example, separate fields are used for adaptation of SSB transmission (e.g., wherein the SSB is always-on SSB in the cell), and activation, and/or deactivation, and/or adaptation of on-demand SSB transmission in the same cell.

For another example, the MAC CE can be the MAC CE used for SCell activation and/or deactivation. For this example, a field can be added to the existing MAC CE for SCell activation and/or deactivation, which can be used for adaptation of SSB transmission.

For yet another example, the MAC CE can be a new or separate MAC CE from the MAC CE for on-demand SSB activation, and/or deactivation, and/or adaptation, or the MAC CE for adaptation of SSB transmission.

For one example, the T_min can include the minimum processing delay for the associated MAC CE.

For another example, the T_min can include the measurement gap for switching the configuration for SSB transmission and/or measurement.

In one embodiment, the DL indication can be a DCI format (e.g., carried by a PDCCH).

For one example, the DCI format can be a DCI format 1_0.
For one instance of this example, the radio network temporary identifier (RNTI) applied to the DCI format can be a paging RNTI (P-RNTI).
For one further implementation, the indication on the adaptation of configurations for SSB can be included in the “Short Messages Indicator” of the DCI format 1_0.
For another further implementation, the indication on the adaptation of configurations for SSB can be included in the “Short Messages” of the DCI format 1_0 (e.g., using reserved bit(s) in the “Short Messages”).

For another example, the DCI format can be a DCI format 1_0.
For one instance, the RNTI applied to the DCI format can be a cell RNTI (C-RNTI) or configured scheduling RNTI (CS-RNTI) or modulation and coding scheme (MCS)-C-RNTI.
For one further implementation, the indication on the adaptation of configurations for SSB can be included in the reserved bit(s) of the DCI format 1_0.

For yet another example, the DCI format can be a DCI format 1_0.
For yet another instance, the RNTI applied to the DCI format can be a system information RNTI (SI-RNTI).
For one further implementation, the indication on the adaptation of configurations for SSB can be included in the reserved bit(s) of the DCI format 1_0.

For yet another example, the DCI format can be a DCI format 1_0.
For yet another instance, the RNTI applied to the DCI format can be a new RNTI.

For yet another example, the DCI format can be a DCI format 2_0.
For one instance, the RNTI applied to the DCI format can be a slot format indication (SFI)-RNTI.
For one further implementation, the indication on the adaptation of configurations for SSB can be included in the reserved bit(s) of the DCI format 2_0.

For yet another example, the DCI format can be a DCI format 2_0.
For one instance, the RNTI applied to the DCI format can be a new RNTI.

For yet another example, the DCI format can be a DCI format 2_9.
For one instance, the RNTI applied to the DCI format can be a cellDTRX-RNTI.
For one further implementation, the indication on the adaptation of configurations for SSB can be included in the reserved bit(s) of the DCI format 2_9.
For yet another further implementation, the indication on the adaptation can be included in block(s), wherein in each block, at least one bit (e.g., log(N_P) bits, wherein N_P is the total number of periodicities or time locations or sets of configuration) per cell or per a group of serving cells, is added for the indication of SSB time domain adaptation. Each block may correspond to the serving cell or the group of serving cells. The block(s) can reuse the ones for cell discontinuous transmission (DTX)/discontinuous reception (DRX) operation.

For yet another example, the DCI format can be a DCI format 2_9.
For one instance, the RNTI applied to the DCI format can be a new RNTI (e.g., dedicated for SSB adaptation purpose).
For one further implementation, the indication on the adaptation can be included in block(s), wherein in each block, at least one bit (e.g., log(N_P) bits, wherein N_P is the total number of periodicities or time locations or sets of configuration) per cell or per a group of serving cells, is added for the indication of SSB time domain adaptation.

For one example, the T_min can be the minimum processing delay (or switching time) for the associated DCI format.

For another example, the T_min can include the measurement gap for switching the configuration for SSB transmission and/or measurement.

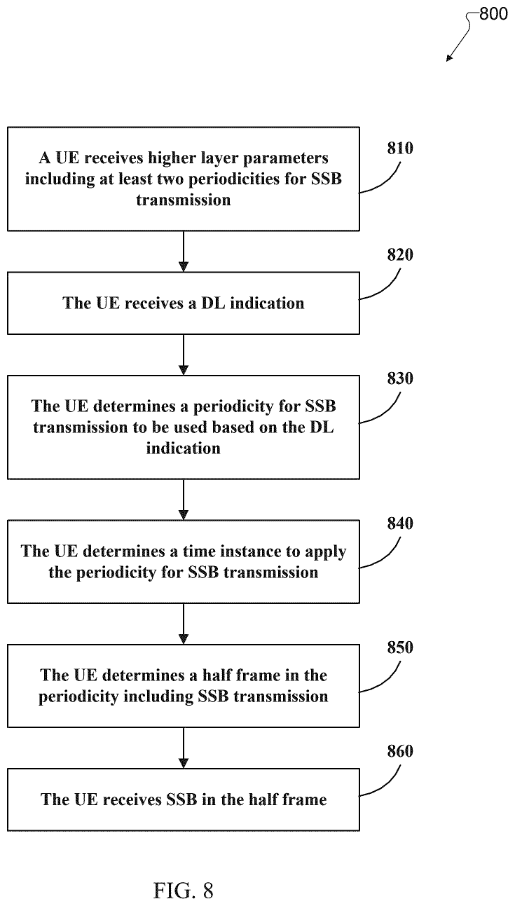

FIG. 8 illustrates a flowchart of an example UE procedure 800 for adapting SSB transmission periodicity according to embodiments of the present disclosure. For example, procedure 800 can be performed by the UE 116 of FIG. 3. This example is for illustration only and other embodiments can be used without departing from the scope of the present disclosure.

In one embodiment, an example UE procedure 800 is shown in FIG. 8. The procedure begins in 810, a UE receives higher layer parameters including at least two periodicities for SSB transmission. In 820, the UE receives a DL indication. In 830, the UE determines a periodicity for SSB transmission to be used based on the DL indication. In 840, the UE determines a time instance to apply the periodicity for SSB. In 850, the UE determines a half frame in the periodicity including SSB transmission. In 860, the UE receives SSB in the half frame.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A base station (BS) in a wireless communication system, the BS comprising:
a processor configured to determine a list of configurations for an adaptation of synchronization signals and physical broadcast channel (SS/PBCH) blocks, wherein each configuration, from the list of configurations, provides (i) a periodicity of the SS/PBCH blocks, (ii) a system frame number (SFN) offset associated with the periodicity, and (iii) a half frame index associated with the periodicity; and
a transceiver operably coupled to the processor, the transceiver configured to transmit a set of higher layer parameters including the list of configurations,
wherein the processor is further configured to:
determine the periodicity of the SS/PBCH blocks after the adaptation based on an indication in a downlink control information (DCI) format;
determine the SFN offset and the half frame index of the SS/PBCH blocks after the adaptation;
determine, based on the periodicity, the SFN offset, and the half frame index, half frames including the SS/PBCH blocks after the adaptation; and
wherein the transceiver is further configured to:
transmit a physical downlink control channel (PDCCH) providing the DCI format; and
transmit, based on the half frames, the SS/PBCH blocks after the adaptation.

2. The BS of claim 1, wherein the DCI format is a DCI format 2_9 with a cyclic redundancy check (CRC) scrambled by a radio network temporary identifier (RNTI) dedicated for the adaptation of SS/PBCH blocks.

3. The BS of claim 1, wherein:
the processor is further configured to determine a time instance to apply the half frames including the SS/PBCH blocks after the adaptation, and
the time instance is based on a slot for receiving the PDCCH with a time domain processing delay.

4. The BS of claim 1, wherein the adaptation of the SS/PBCH blocks is for a secondary cell (SCell).

5. The BS of claim 1, wherein the SS/PBCH blocks are not associated with a system information block 1 (SIB1).

6. The BS of claim 1, wherein:
the processor is further configured to:
determine a first periodicity and a first set of half frames for the SS/PBCH blocks before the adaptation; and
determine a second periodicity and a second set of half frames for the SS/PBCH blocks after the adaptation;
the first set of half frames are a subset of the second set of half frames, when the first periodicity is larger than the second periodicity; and
the second set of half frames are a subset of the first set of half frames, when the second periodicity is larger than the first periodicity.

7. The BS of claim 1, wherein the processor is further configured to:
determine, based on the set of higher layer parameters, a list of SS/PBCH-block-based measurement timing configurations (SMTCs), wherein SMTCs from the list of SMTCs are associated with configurations in the list of configurations, respectively; and
determine a SMTC, from the list of SMTCs, based on the periodicity.

8. A user equipment (UE) in a wireless communication system, the UE comprising:
a transceiver configured to receive a set of higher layer parameters; and
a processor operably coupled to the transceiver, the processor configured to determine, based on the set of higher layer parameters, a list of configurations for an adaptation of synchronization signals and physical broadcast channel (SS/PBCH) blocks, wherein each configuration, from the list of configurations, provides (i) a periodicity of the SS/PBCH blocks, (ii) a system frame number (SFN) offset associated with the periodicity, and (iii) a half frame index associated with the periodicity,
wherein the transceiver is further configured to receive a physical downlink control channel (PDCCH) providing a downlink control information (DCI) format,
wherein the processor is further configured to:
determine the periodicity of the SS/PBCH blocks after the adaptation based on an indication in the DCI format;
determine the SFN offset and the half frame index of the SS/PBCH blocks after the adaptation;
determine, based on the periodicity, the SFN offset, and the half frame index, half frames including the SS/PBCH blocks after the adaptation, and
wherein the transceiver is further configured to receive, based on the half frames, the SS/PBCH blocks after the adaptation.

9. The UE of claim 8, wherein the DCI format is a DCI format 2_9 with a cyclic redundancy check (CRC) scrambled by a radio network temporary identifier (RNTI) dedicated for the adaptation of the SS/PBCH blocks.

10. The UE of claim 8, wherein:
the processor is further configured to determine a time instance to apply the half frames including the SS/PBCH blocks, and
the time instance is based on a slot for receiving the PDCCH with a time domain processing delay.

11. The UE of claim 8, wherein the adaptation of the SS/PBCH blocks is for a secondary cell (SCell).

12. The UE of claim 8, wherein the SS/PBCH blocks are not associated with a system information block 1 (SIB1).

13. The UE of claim 8, wherein:
the processor is further configured to:
determine a first periodicity and a first set of half frames for the SS/PBCH blocks before the adaptation; and
determine a second periodicity and a second set of half frames for the SS/PBCH blocks after the adaptation;
the first set of half frames are a subset of the second set of half frames, when the first periodicity is larger than the second periodicity; and
the second set of half frames are a subset of the first set of half frames, when the second periodicity is larger than the first periodicity.

14. The UE of claim 8, wherein the processor is further configured to:
determine, based on the set of higher layer parameters, a list of SS/PBCH-block-based measurement timing configurations (SMTCs), wherein SMTCs from the list of SMTCs are associated with configurations from the list of configurations, respectively;
determine a SMTC, from the list of SMTCs, based on the periodicity; and
determine to perform a radio resource management (RRM) measurement based on the SMTC after the adaptation.

15. A method of a user equipment (UE) in a wireless communication system, the method comprising:
receiving a set of higher layer parameters;
determining, based on the set of higher layer parameters, a list of configurations for an adaptation of a synchronization signals and physical broadcast channel (SS/PBCH) blocks, wherein each configuration, from the list of configurations, provides (i) a periodicity of the SS/PBCH blocks, (ii) a system frame number (SFN) offset associated with the periodicity, and (iii) a half frame index associated with the periodicity;
receiving a physical downlink control channel (PDCCH) providing a downlink control information (DCI) format;
determining the periodicity of the SS/PBCH blocks after the adaptation based on an indication in the DCI format;
determining the SFN offset and the half frame index of the SS/PBCH blocks after the adaptation;
determining, based on the periodicity, the SFN offset, and the half frame index, half frames including the SS/PBCH blocks after the adaptation; and
receiving, based on the half frames, the SS/PBCH blocks after the adaptation.

16. The method of claim 15, wherein the DCI format is a DCI format 2_9 with a cyclic redundancy check (CRC) scrambled by a radio network temporary identifier (RNTI) dedicated for the adaptation of the SS/PBCH blocks.

17. The method of claim 15, further comprising:
determining a time instance to apply the half frames including first SS/PBCH blocks,
wherein the time instance is based on a slot for receiving the PDCCH with a time domain processing delay.

18. The method of claim 15, wherein:
the adaptation of the SS/PBCH blocks is for a secondary cell (SCell); and
the SS/PBCH blocks are not associated with a system information block 1 (SIB1).

19. The method of claim 15, further comprising:
determining a first periodicity and a first set of half frames for the SS/PBCH blocks before the adaptation; and
determining a second periodicity and a second set of half frames for the SS/PBCH blocks after the adaptation,
wherein the first set of half frames are a subset of the second set of half frames, when the first periodicity is larger than the second periodicity, and
wherein the second set of half frames are a subset of the first set of half frames, when the second periodicity is larger than the first periodicity.

20. The method of claim 15, further comprising:
determining, based on the set of higher layer parameters, a list of SS/PBCH-block-based measurement timing configurations (SMTCs), wherein SMTCs from the list of SMTCs are associated with configurations in the list of configurations, respectively;
determining a SMTC, from the list of SMTCs, based on the periodicity; and
determining to perform a radio resource management (RRM) measurement based on the SMTC after the adaptation.
